(19) United States
(12) Patent Application Publication
(10) Pub. No.: US 2026/0360256 A1
(43) Pub. Date: Nov. 12, 2026

(54) SYSTEM AND METHOD FOR MANAGING DIGITAL ACCESS CREDENTIALS FOR A PLATOON OF VEHICLES

(71) Applicant: GM Global Technology Operations LLC, Detroit, MI (US)

(72) Inventors: Venkata Naga Siva Vikas Vemuri, Farmington Hills, MI (US); John Sergakis, Bloomfield Hills, MI (US); Ahmed F. Al Alawy, Canton, MI (US); Azin Neishaboori, Plymouth, MI (US)

(21) Appl. No.: 19/202,310

(22) Filed: May 8, 2025

(51) Int. Cl. G08G 1/00; H04L 9/40; H04W 4/46

(52) U.S. Cl. CPC G08G 1/22; H04L 63/068; H04L 63/108; H04W 4/46

(57) ABSTRACT

A method for managing digital access credentials for a platoon of vehicles includes a controller in a lead vehicle receiving a digital-key credential data transmitted by one or more follower vehicles when joining the platoon of vehicles. The digital-key credential data includes a valid key value and is stored in a lead-follower key matrix. The method further includes the lead vehicle selecting a centralized access mode or a de-centralized access mode for an upcoming access transaction. The lead vehicle transmits the digital-key credential data to a remote back-office, receiving credentials. For the centralized access mode, the lead vehicle executes an access transaction with a local device using the credentials received. For the de-centralized access mode, the lead vehicle forwards the credentials received to a corresponding follower vehicle and the one or more follower vehicles execute the access transaction. The method further includes deactivating access to the digital-key credential data.

### INTRODUCTION

The present disclosure relates to a system and method for managing digital access credentials. More specifically, the present disclosure relates to a system and method for managing digital access credentials for a platoon of vehicles.

A platoon of vehicles includes a lead vehicle and one or more follower vehicles. The lead vehicle receives data from the one or more follower vehicles and coordinates driving responses for each of the vehicles in the platoon of vehicles based on the data received. However, the data received may not be verified, leading to security risks.

Thus, while current platoon of vehicles achieve their intended purpose, there is a need for a new and improved method for managing digital access credentials for the platoon of vehicles.

### SUMMARY

According to several aspects, a method for managing digital access credentials for a platoon of vehicles is provided. The platoon of vehicles includes a lead vehicle and one or more follower vehicles. The method includes receiving, by a controller in the lead vehicle, a digital-key credential data transmitted by the one or more follower vehicles when joining the platoon of vehicles. The method further includes storing the digital-key credential data in a lead-follower key matrix that, for each follower vehicle, records at least a key sharing parameter. The key sharing parameter includes a valid key value having a start time and an end time. The start time and end time verify a validity of the digital-key credential data. The method further includes selecting, by the lead vehicle, either a centralized access mode or a de-centralized access mode for an upcoming access transaction. The selection being based on a current route segment and trajectory of the platoon of vehicles and an available number of key slots in the lead vehicle. The method further includes transmitting, by the lead vehicle, the digital-key credential data to a remote back-office. The method further includes executing, by the lead vehicle, an access transaction with a local device using credentials received from the remote back-office for the centralized access mode. The method further includes forwarding, by the lead vehicle, the credentials received from the remote back-office to a corresponding follower vehicle for the de-centralized access mode. The method further includes executing, by the one or more follower vehicles, the access transaction with the local device using the credentials received from the remote back-office for the de-centralized access mode. The method further includes deactivating the lead vehicle access to the digital-key credential data, removing the one or more follower vehicles from the platoon of vehicles.

In an additional aspect of the present disclosure, the method further includes consolidating the digital-key credential data from the one or more follower vehicles within the lead-follower key matrix.

In another aspect of the present disclosure, the method further includes communicating, by the controller within the lead vehicle, instructions from the lead vehicle to the one or more follower vehicles within the platoon of vehicles.

In another aspect of the present disclosure, the instructions from the lead vehicle determines a speed of the one or more follower vehicles and an inter-distance range between consecutive vehicles.

In another aspect of the present disclosure, the digital-key credential data includes a sharable attribute. The sharable attribute determines the lead vehicle leaving the platoon of vehicles. The lead vehicle shares the digital-key credential data to one of the one or more follower vehicles.

In another aspect of the present disclosure, the method further includes executing, by the one or more follower vehicles, an access negotiation with the local device using the credentials received from the remote back-office for the de-centralized access mode.

In another aspect of the present disclosure, the method further includes executing, by the lead vehicle, an access negotiation with the local device using the credentials received from the remote back-office for the centralized access mode.

In another aspect of the present disclosure, the method further includes notifying, by the lead vehicle, the one or more follower vehicles about the access transaction and the access negotiation executed on behalf of the one or more follower vehicles.

In another aspect of the present disclosure, the lead-follower key matrix has a storage threshold. The storage threshold creates a limit for the lead vehicle executing the access transaction with the local device for the one or more follower vehicles in the centralized access mode.

In another aspect of the present disclosure, when one or more follower vehicles exceed the storage threshold, the one or more follower vehicles that exceed the storage threshold execute the access transaction with the local device.

According to several aspects, a system for managing digital access credentials for a platoon of vehicles is provided. The platoon of vehicles includes a lead vehicle and one or more follower vehicles. The system includes a controller in the lead vehicle receiving a digital-key credential data transmitted by the one or more follower vehicles when joining the platoon of vehicles. The system further includes a lead-follower key matrix storing the digital-key credential data for each follower vehicle. The digital-key credential data records at least a key sharing parameter. The key-sharing parameter includes a valid key value having a start time and an end time. The start time and end time verifying a validity of the digital-key credential data. The key-sharing parameter further includes a shared keys values, sharing at least one key within the digital-key credential data from the one or more follower vehicles. The key-sharing parameter further includes a shareable keys value. The one or more follower vehicles determine sharable keys within the digital-key credential data. The key-sharing parameter further includes an entitlement value. The one or more follower vehicles identify access of the digital-key credential data by the lead vehicle. The system further includes the lead vehicle selecting an access mode for an upcoming access transaction, based on a current route segment and trajectory of the platoon of vehicles and an available number of key slots in the lead vehicle. The access mode includes a centralized access mode. The lead vehicle transmits the digital-key credential data to a remote back-office. The lead vehicle executing an access transaction and an access negotiation with a local device using credentials received from the remote back-office. The lead vehicle executing an access negotiation with the local device using the credentials received from the remote back-office. The access mode further includes a de-centralized access mode. The lead vehicle transmits the digital-key credential data to a remote back-office. The lead vehicle forwarding the credentials received from the remote back-office to a corresponding follower vehicle. The one or more follower vehicles executing the access transaction and the access negotiation with the local device using the credentials received from the remote back-office. The system includes the one or more follower vehicles removed from the platoon of vehicles, deactivating the lead vehicle access to the digital-key credential data.

In another aspect of the present disclosure, the system further includes the lead-follower key matrix of the lead vehicle consolidating the digital-key credential data from the one or more follower vehicles.

In another aspect of the present disclosure, the controller within the lead vehicle communicating instructions from the lead vehicle to the one or more follower vehicles within the platoon of vehicles.

In another aspect of the present disclosure, the instructions from the lead vehicle determines a speed of the one or more follower vehicles and an inter-distance range between consecutive vehicles.

In another aspect of the present disclosure, the digital-key credential data includes a sharable attribute. The sharable attribute determines the lead vehicle leaving the platoon of vehicles. The lead vehicle sharing the digital-key credential data to one of the one or more follower vehicles.

In another aspect of the present disclosure, the system further includes the lead vehicle notifying the one or more follower vehicles about the access transaction and the access negotiation executed on behalf of the one or more follower vehicles.

In another aspect of the present disclosure, the lead-follower key matrix has a storage threshold. The storage threshold creates a limit for the lead vehicle executing the access transaction with the local device for the one or more follower vehicles in the centralized access mode.

In another aspect of the present disclosure, when one or more follower vehicles exceed the storage threshold, the one or more follower vehicles that exceed the storage threshold execute the access transaction with the local device.

According to several aspects, a method for managing digital access credentials for a platoon of vehicles is provided. The platoon of vehicles includes a lead vehicle and one or more follower vehicles. The method includes receiving, by a controller in the lead vehicle, a digital-key credential data transmitted by the one or more follower vehicles when joining the platoon of vehicles. The method further includes storing the digital-key credential data in a lead-follower key matrix that, for each follower vehicles, records at least a key sharing parameter. The key sharing parameter includes a valid key value having a start time and an end time. The start time and end time verify a validity of the digital-key credential data. The key sharing parameter further includes a shared keys values. The shared keys values sharing at least one key within the digital-key credential data from the one or more follower vehicles. The key sharing parameters further include an entitlement value. The one or more follower vehicles identify access of the digital-key credential data by the lead vehicle. The method further includes selecting, by the lead vehicle, either a centralized access mode or a de-centralized access mode for an upcoming access transaction. The selection being based on a current route segment and trajectory of the platoon of vehicles and an available number of key slots in the lead vehicle. The method further includes transmitting, by the lead vehicle, the digital-key credential data to a remote back-office. The method further includes communicating, by the controller in the lead vehicle, instructions from the lead vehicle to the one or more follower vehicles. The instructions include determining a speed of the one or more follower vehicles, thereby coordinating the speed of the one or more follower vehicles with the lead vehicle. The instructions further include determining an inter-distance range between each vehicle in the platoon of vehicles. The method further includes executing, by the lead vehicle, an access transaction with a local device using credentials received from the remote back-office for the centralized access mode. The method further includes executing, by the lead vehicle, an access negotiation with the local device using the credentials received from the remote back-office for the centralized access mode. The method further includes forwarding, by the lead vehicle, the credentials received from the remote back-office to a corresponding follower vehicle for the de-centralized access mode. The method further includes executing, by the one or more follower vehicles, the access transaction with the local device using the credentials received from the remote back-office for the de-centralized access mode. The method further includes executing, by the one or more follower vehicles, the access negotiation with the local device using the credentials received from the remote back-office for the de-centralized access mode. The method further includes notifying, by the lead vehicle, the one or more follower vehicles about the access transaction and the access negotiation executed on behalf of the one or more follower vehicles. The method further includes deactivating the lead vehicle access to the digital-key credential data, removing the at least one follower vehicles from the platoon of vehicles.

In another aspect of the present disclosure, the lead-follower key matrix has a storage threshold. The storage threshold creates a limit for the lead vehicle executing the access transaction and the access negotiation on behalf of the one or more follower vehicles. When one or more follower vehicles exceed the storage threshold, the one or more follower vehicles that exceed the storage threshold execute the access transaction and the access negotiation with the local device.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic drawing of a platoon of vehicles according to an exemplary embodiment.

FIG. 2 is a schematic drawing of a platoon of vehicles in a centralized access mode according to an exemplary embodiment.

FIG. 3 is a schematic drawing of a platoon of vehicles in a de-centralized access mode according to an exemplary embodiment.

FIG. 4 is a flow chart for a method of the platoon of vehicles in the centralized access mode according to an exemplary embodiment.

FIG. 5 is a flow chart for a method of the platoon of vehicles in the de-centralized access mode according to an exemplary embodiment.

### DETAILED DESCRIPTION

The following description is merely exemplary in nature and is not intended to limit the present disclosure, application, or uses.

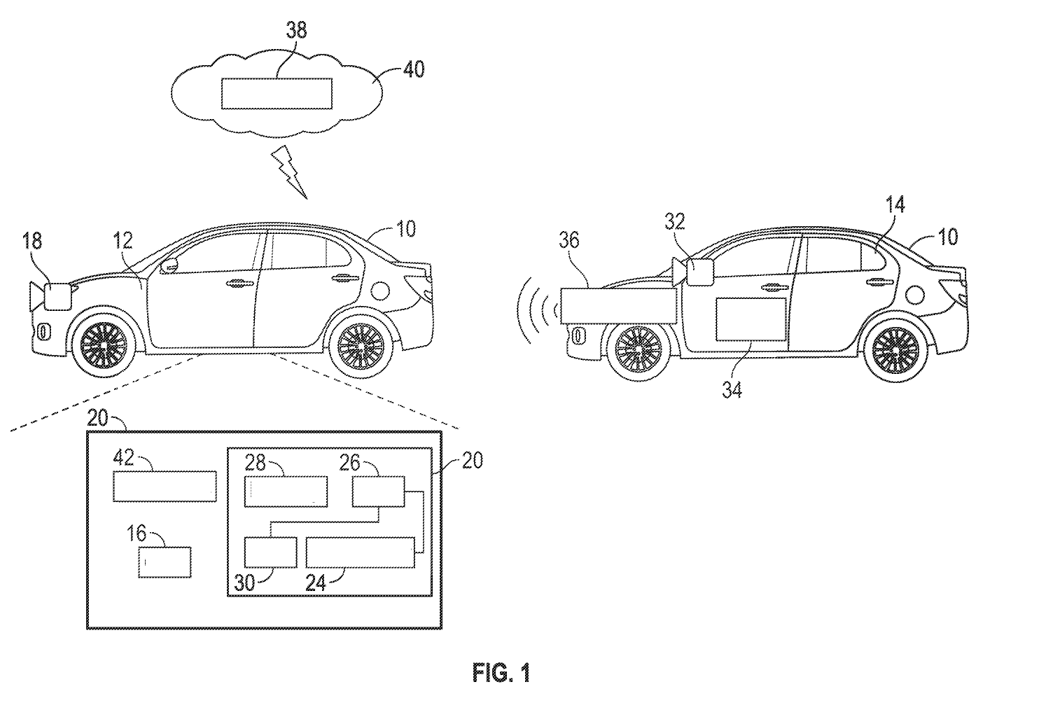

Referring to FIG. 1, a schematic diagram of a platoon of vehicles 10 is illustrated. The platoon of vehicles 10 includes a lead vehicle 12 and one or more follower vehicles 14 traveling closely together in the same direction. The lead vehicle 12 communicates with the one or more follower vehicles 14 to coordinate driving responses of the one or more follower vehicles 14. During the course of travel, the overall number of the participating vehicles in the platoon of vehicles 10 may change. Vehicles may request to join the platoon of vehicles 10 and the one or more follower vehicles 14 may request to leave the platoon of vehicles 10, causing the lead vehicle 12 to maintain and update communication with each of the one or more follower vehicles 14. It is to be appreciated that FIG. 1 is merely exemplary in nature and the lead vehicle 12 and the one or more follower vehicle 14 in the platoon of vehicles 10 may be any type of vehicle such as, but not limited to, a sedan, a truck, sport utility vehicle, van, or motor home.

The lead vehicle 12 collects data through a first global positioning system (GPS) 16 and a first sensor set 18 disposed within the lead vehicle 12. The first sensor set 18 is in communication with a controller 20 disposed within the lead vehicle 12. The first GPS 16 provides a location of the lead vehicle 12, allowing the lead vehicle 12 to navigate and communicate the location of the lead vehicle 12 to the one or more follower vehicles 14. The first sensor set 18 is configured to generate a signal based on the sensed observable conditions of the exterior environment of the lead vehicle 12. The first sensor set 18 may be, but is not limited to, one or more sensors including a radio detection and ranging (RADAR) sensor, a light detection and ranging (LIDAR) sensor, a proximity sensor, a ground penetrating radar (GPR) sensor, and/or a camera (e.g., optical cameras and/or infrared cameras). The first sensor set 18 allows the lead vehicle 12 to determine an inter-distance with the one or more of follower vehicles 14 and communicate the inter-distance. It should be appreciated that the first sensor set 18 is disposed within the lead vehicle 12 and may include any number of sensors without departing from the scope of the present disclosure.

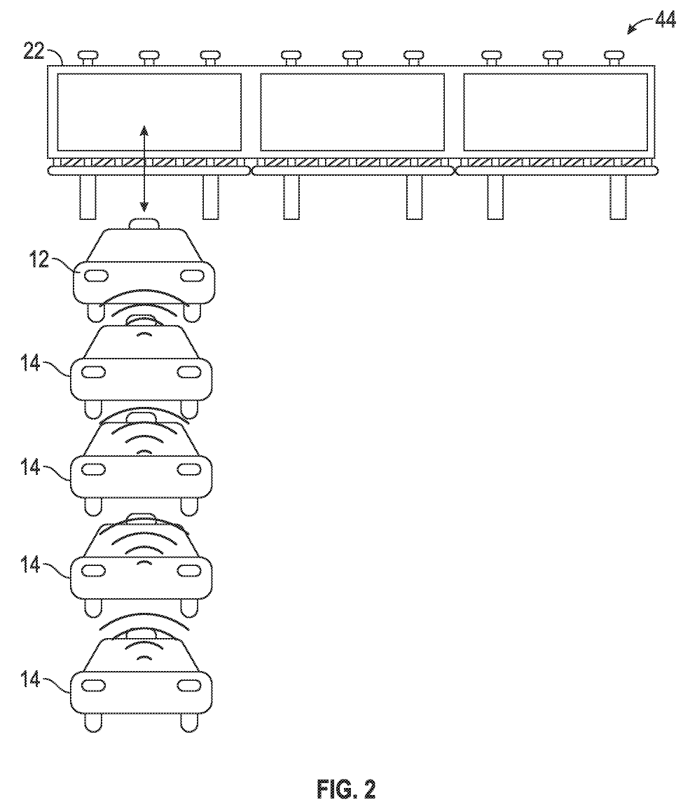

The first sensor set 18 senses observable conditions of the exterior of the lead vehicle 12. The observable conditions include road conditions, driving conditions surrounding the lead vehicle 12, and a local device 22 (shown in FIG. 2). The road conditions include but are not limited to roadway curvature, traffic patterns, intersection configurations, paved, unpaved, presence of precipitation, etc. The local device 22 (shown in FIG. 2) may include, but is not limited to, vehicles not included in the platoon of vehicles 10, toll systems, parking system, and charging stations.

The controller 20, in the lead vehicle 12, coordinates driving responses between the lead vehicle 12 and the one or more follower vehicles 14. The coordinated responses may include, but not limited to, a speed and an inter-distance range. The controller determines the speed where the lead vehicle 12 and each of the one or more follower vehicles 14 travel at the determined speed. Additionally, the controller defines the inter-distance range and maintains each of the vehicles in the platoon of vehicles 10 within the defined inter-distance range between each consecutive vehicle. The coordinated responses improve the aerodynamic effectiveness and performance, increasing the capacity of roads and provides a more steady-state traffic flow. The controller 20 is a non-generalized electronic control device having a preprogrammed digital computer or processor 26, a memory 28, an input and output ports 30, and the transceiver 24.

The processor 26 can be a custom made or a commercially available processor, a central processing unit (CPU), a graphics processing unit (GPU), an auxiliary processor among several processors associated with the controller 20, a semiconductor-based microprocessor (in the form of a microchip or chip set), a macroprocessor, a combination thereof, or generally a device for executing instructions. The memory 28 is used to store and record data from a lead-follower key matrix 42, including a digital-key credential data described in further detail below. The memory 28 further stores control logic, software applications, instructions, computer code, data, lookup tables, etc. The memory 28 includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

The input and output ports 30 receive incoming data from the first sensor set 18 and the first GPS 16. The incoming data is communicated to the processor 26. The input and output ports 30 also receive data from the one or more follower vehicles 14 described in further detail below. The processor 26 processes the incoming data and the data received from the one or more follower vehicles 14 to determine and communicate instructions from the lead vehicle 12 to the one or more follower vehicles 14.

The transceiver 24 is configured to wirelessly communicate information to and from the lead vehicle 12, such as but not limited to, vehicle-to-vehicle (V2V) communication, vehicle-to-infrastructure (V2I) communication, remote systems at a remote call center (e.g., ON-STAR by GENERAL MOTORS) and/or personal devices. The communication with the remote systems may be via a cellular link, a Wi-Fi link, a satellite link, or other radio frequency (RF) technologies. The lead vehicle 12 may include one or more antennas and/or transceivers 24 for receiving and/or transmitting signals, such as cooperative sensing messages (CSMs).

The lead vehicle 12 wirelessly communicates with the one or more follower vehicles 14 via V2V communication, requesting data from the one or more follower vehicles 14. The one or more follower vehicles 14 includes a second sensor set 32, a second GPS 34, and a follower key matrix 36, storing the requested data. The second sensor set 32 disposed in the one or more follower vehicles 14 senses observable conditions external to the one or more follower vehicles 14. The second GPS 34 provides a location of the one or more follower vehicles 14. The follower key matrix 36 holds the digital-key credential data. The digital-key credential data includes at least a key sharing parameter.

The key sharing parameter includes at least a valid key value, a shared keys value, a shareable keys value, and an entitlement value. The valid key value identifies a start time and an end time verifying the validity of the digital-key credential data. The shared keys value identifies the values of the keys shared between the lead vehicle 12 and the one or more follower vehicles 14. The shareable keys value identifies the values which the one or more follower vehicles 14 determines which of the keys may be shared with the lead vehicle 12. The entitlement value identifies access of the lead vehicle 12 to the keys shared by the one or more follower vehicles 14. For example, the lead vehicle 12 may have full access, limited access, and/or drive capabilities.

To verify credentials of the digital-key credential data for each of the one or more follower vehicles 14, the lead vehicle forwards the digital-key credential data to a remote back-office 38 in a cloud 40. The remote back-office 38 verifies the credentials by a server authenticating the signature with a vehicle public key and cross-checks the data against a secure credential database. The remote back-office 38 transmits results of the digital-key credential data for each of the one or more follower vehicles 14 back to the lead vehicle 12. The results may include the credentials being not verified or verified. The lead vehicle 12 denies the one or more follower vehicles 14 with credentials that are not verified from joining the platoon of vehicles 10, decreasing security risks in the platoon of vehicles 10.

Alternatively, the lead vehicle 12 allows the one or more follower vehicles 14 with verified credentials to join the platoon of vehicles 10, allowing the lead vehicle 12 to obtain access and to manage the verified digital-key credential data. Access to manage the digital-key credential data enables the lead vehicle 12 to determine one or more operating parameters of the platoon of vehicles 10. For example, the lead vehicle 12 may determine the speed for each vehicle in the platoon of vehicles 10, the inter-distance between consecutive vehicles in the platoon of vehicles 10, and/or allowing the lead vehicle 12 to perform some or all of access negotiations and/or access transactions with an external entity, on behalf of all vehicles in the platoon of vehicles 10. The external entity may be a remote entity or the local device 22 such as, but not limited to, a remote tolling system, a road usage system, a locally controlled access gate, or a remotely controlled access gate.

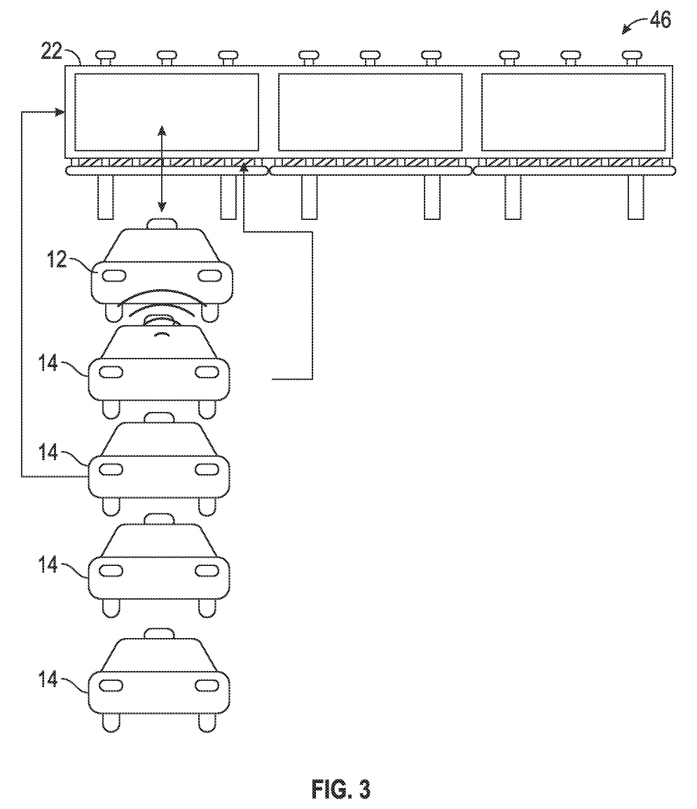

Referring to FIGS. 2 and 3, a schematic drawing of the platoon of vehicles 10 is illustrated. The lead vehicle 12 may select an access mode to control and manage the digital-key credential data. The access mode may be a centralized access mode 44 or a de-centralized access mode 46. The selection may be based on a prior configuration in the controller 20 of the lead vehicle 12, specifying either the centralized access mode 44 or the de-centralized access mode 46. Additionally, the selection may be based on a current route segment and trajectory of the platoon of vehicles 10, an available number of key slots in the lead-follower key matrix 42, and a prior configuration in the one or more follower vehicles 14. The prior configuration in the one or more follower vehicles 14 specifies a selection of the centralized access mode 44, a selection of the de-centralized access mode 46, a preference for either the centralized access mode 44 or the de-centralized access mode 46.

For example, when the number of vehicles in the platoon of vehicles 10 exceeds a threshold, the de-centralized access mode 46 may result in overwhelming the local device 22 or the remote system of the local device 22. The remote system of the local device 22 manages the access negotiations and/or the access transactions. Accordingly, the centralized access mode is selected, having the lead vehicle 12 perform the access negotiation and the access transaction on behalf of all vehicles in the platoon of vehicles 10, improving the flow of traffic, and/or fuel usage efficiency in the platoon of vehicles 10.

Alternatively, there may be a road segment wherein multiple toll lanes are available and used by multiple vehicles in the platoon of vehicles 10 concurrently. For example, six vehicles in the platoon of vehicles 10 travel through a six-lane toll zone. The de-centralized access mode 46 may be advantageous. The lead vehicle 12 performs the access negotiation with the local device 22, while each of the one or more follower vehicles 14 performs the access transaction exchanges with the local device 22. Alternatively, there may be specific access restrictions in a specific road segment which prohibit keeping a gate open for all vehicles in the platoon of vehicles 10 at once, requiring data collection from each vehicle passing through the gate, making the de-centralized access mode 46 preferable.

Alternatively, the local device 22 or the backend system supporting the local device 22 may have a preference or selection of either the centralized access mode 44 or the de-centralized access mode 46. The preference or selection may be sent to the lead vehicle 12 via a handshaking message or an advertisement. The preference is used by the lead vehicle 12 to determine whether to use the centralized access mode 44 or the de-centralized access mode 46.

There may also be a hybrid access mode where some of the one or more follower vehicles 14 use the centralized access mode 44, allowing the lead vehicle 12 to represent some of the one or more follower vehicles 14 in the access negotiation and/or the access transaction. While some of the one or more follower vehicles 14 use the centralized access mode 44, different one or more of follower vehicles 14 use the de-centralized access mode 46. For example, the platoon of vehicles 10 may include twelve vehicles going through a three toll-lane zone. The lead vehicle 12 provides the access negotiation and the access transaction on behalf of three of the one or more follower vehicles 14. The remaining eight of the one or more follower vehicles 14, using the other lanes, perform the access transaction exchanges on their own behalf. It is to be appreciated that FIGS. 2 and 3 are merely exemplary in nature and the local device 22 is not limited to a toll system. The local device 22 may also be vehicles not included in the platoon of vehicles 10, parking systems, or charging stations.

FIG. 2 illustrates the platoon of vehicles 10 in the centralized access mode 44. In the centralized access mode 44, the lead vehicle 12 receives at least the key sharing parameters for each of the one or more follower vehicles 14 and consolidates and stores the key sharing parameters in the lead-follower key matrix 42 stored in the lead vehicle 12. During platooning, the lead vehicle 12 may sense the local device 22 within a predetermined proximity. The predetermined proximity may be, but is not limited to, within 30, 60, or 120 feet from the local device 22. Once the platoon of vehicles 10 reaches the local device 22 within the predetermined proximity, the lead vehicle 12 may execute the access transaction and/or the access negotiation with the local device 22 using a local short-range or a long-range communication. The long-range communication uses internet access, for and on behalf of each of the one or more follower vehicles 14.

The access negotiation between the lead vehicle 12 and the local device 22 may include the lead vehicle 12 presenting digital material to the local device 22, allowing the lead vehicle 12 to identify and authenticate itself with the local device 22. Additionally, the digital material allows the lead vehicle 12 to prove its right of access or passage to the local device 22. The digital material may be, but is not limited to, a pre-negotiated certificate stored within the lead vehicle 12. The local device 22 may accept the pre-negotiated certificate or the backend system of the local device 22 may perform determination of acceptability of the pre-negotiated certificate. The access transaction between the lead vehicle 12 and local device 22 includes determination of a fee that needs to be paid for the lead vehicle 12 and any of the one or more follower vehicles 14 that the lead vehicle 12 represents in performing the access transaction. For example, the lead vehicle 12 determines the fee that needs to be paid for the platoon of vehicles 10 to use a road or pass through a gated or restricted access area. The local device 22 may in turn use database resources from its local computer and the remote backend system to compute a transaction fee. The local device 22 communicates the transaction fee with the lead vehicle 12.

Alternatively, the local device 22 may be a virtual local device and enforced by a geofence configured on the lead vehicle 12 to enforce different access negotiation and access transaction policies as the platoon of vehicles 10 cross a state border, a country border, a county border, or enter/exit any region with specific access policies. The access transaction and/or the access negotiation executed is based on the digital-key credential data stored in the lead-follower key matrix 42. Executing the access transaction and the access negotiation for each of the one or more follower vehicles 14 at once promotes efficiency for each of the access transactions and the access negotiations.

The lead-follower key matrix 42 is a data structure stored in the lead vehicle 12 that, for each follower, stores the follower’s digital-key credential data. The follower’s digital-key credential data includes the validity window, shared-key count, shareable-key count, and entitlement value. The follower’s digital-key credential data are stored within the lead-follower key matrix 42 within a finite set of key slots, enabling the lead vehicle 12 to authenticate those credentials and conduct the access negotiations and/or the access transactions for the entire platoon of vehicles 10. The lead-follower key matrix 42 has a storage limit or storage threshold for the key slots. The storage limit defines a maximum number of key slots that may be stored in the lead-follower key matrix 42, creating a limit of access transactions and access negotiations the lead vehicle 12 may execute. The overall number of participating vehicles in the platoon of vehicles 10 may change. Additional vehicles may be added to the number of one or more follower vehicles 14. The digital-key credential data from the additional vehicles may exceed the storage limit. If the digital-key credential data of the additional vehicles exceed the storage limit, the lead vehicle 12 does not execute the access transaction or the access negotiation for the additional vehicles. However, the lead vehicle 12 will continue to coordinate driving instructions for the additional vehicles. For example, the lead vehicle 12 may coordinate driving instructions through a short-range V2V communication.

FIG. 3 illustrates the platoon of vehicles 10 in the de-centralized access mode 46. In the de-centralized access mode 46, the lead vehicle 12 receives the verified credentials from the remote back-office 38. Once the platoon of vehicles 10 reaches the predetermined proximity, the lead vehicle 12 forwards the verified credentials to corresponding follower vehicles 14 and transmits instructions to each of the one or more follower vehicles 14 via V2V communication. The one or more follower vehicles 14 follow the instructions provided by the lead vehicle 12 and execute the access transaction and/or the access negotiation with the local device 22 via V2I communication. Instructing responses for each of the one or more follower vehicles promotes efficiency for the access transaction and the access negotiation.

For example, the access negotiation between the one or more follower vehicles 14 and the local device 22 may include the lead vehicle 12 presenting digital material to the local device 22, allowing the lead vehicle 12 to identify and authenticate itself with the local device 22. Additionally, the digital material allows the lead vehicle 12 to prove its right of access or passage to the local device 22. The digital material may be, but is not limited to, the pre-negotiated certificate stored within the lead vehicle 12. The local device 22 may accept the pre-negotiated certificate or the backend system of the local device 22 may perform determination of acceptability of the pre-negotiated certificate. The access transaction between the one or more follower vehicles 14 and local device 22 includes determination of a fee that needs to be paid and local device 22 communicates the transaction fee with the lead vehicle 12. Once the determination of fee is communicated to the lead vehicle 12, the lead vehicle 12 communicates the fee to the one or more follower vehicles 14 and instructs the one or more follower vehicles 14 to conduct the access transaction.

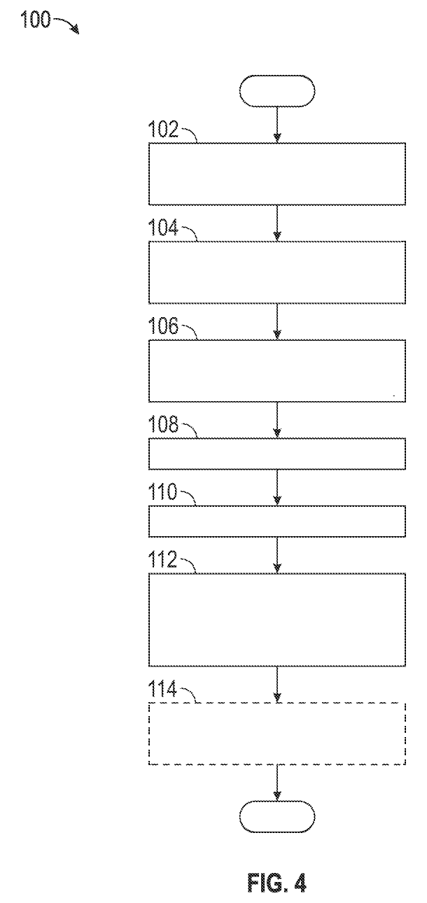

Referring to FIG. 4, a flowchart for a method 100 for managing digital access credentials for a platoon of vehicles in the centralized access mode 44 is illustrated. The method 100 begins at step 102. At step 102, the lead vehicle 12 communicates with the one or more follower vehicles 14, requesting data from the one or more follower vehicles 14. The method 100 proceeds with step 104.

At step 104, the one or more follower vehicles 14 transmits their respective digital-key credential data to the lead vehicle 12, allowing the lead vehicle 12 access to manage the digital-key credential data. The digital-key credential data includes at least the key sharing parameter. The key sharing parameter includes at least a valid key value, a shared keys value, a shareable keys value, and an entitlement value. The valid key value identifies a start time and an end time verifying the validity of the digital-key credential data. The shared keys value identifies the values of the keys shared between the lead vehicle 12 and the one or more follower vehicles 14. The shareable keys value identifies the values which the one or more follower vehicles 14 determines which of the keys may be shared with the lead vehicle 12. The entitlement value identifies access of the lead vehicle 12 to the keys shared by the one or more follower vehicles 14. For example, the lead vehicle 12 may have full access, limited access, and drive capabilities. Full access allows the lead vehicle 12 to perform all access functions for the one or more follower vehicles 14 with no limitations or restrictions. Limited access allows the one or more follower vehicles 14 to create access restrictions while sharing the keys to the lead vehicle 12. Drive capabilities allow the lead vehicle 12 to perform driving actions when the one or more follower vehicles 14 are in motion and require other capabilities that are tied to a digital access system.

The shared keys may have a ‘sharable’ attribute, indicating whether the shared keys may be shared by the lead vehicle 12 to any of the one or more follower vehicles 14 when the lead vehicle 12 is about to leave the platoon of vehicles 10 or stop serving as the lead vehicle 12 of the platoon of vehicles 10. For example, the sharable attribute is set for vehicle C to share the shared keys with lead vehicle A. The lead vehicle A, while terminating its lead role and/or leaving the platoon of vehicles 10, may share the shared keys with vehicle B. Vehicle B would serve as a new lead vehicle, eliminating the need for vehicle B to exchange further key-sharing messages with vehicle C. The digital-key credential data is received by the controller 20 of the lead vehicle 12. The method 100 proceeds with step 106.

At step 106, the lead vehicle 12 transmits the digital-key credential data from each of the one or more follower vehicles 14 to the remote back-office 38. The method 100 proceeds with step 108. At step 108, the remote back-office 38 receives the digital-key credential data and verifies the credentials of each of the digital-key credential data. The method 100 proceeds with step 110.

At step 110, the lead vehicle 12 allows the one or more follower vehicles 14 with verified credentials to join the platoon of vehicles 10. The method 100 proceeds with step 112. At step 112, the lead vehicle 12 executes the access transaction and/or the access negotiation with the local device 22 on behalf of each of the one or more follower vehicles 14 based on the digital-key credential data received. The lead vehicle 12 notifies the one or more follower vehicles 14 about the access transaction and/or the access negotiation executed. The method 100 proceeds with step 114. At step 114, the one or more follower vehicles 14 may deactivate access to the digital-key credential data, removing the one or more follower vehicles 14 from the platoon of vehicles 10.

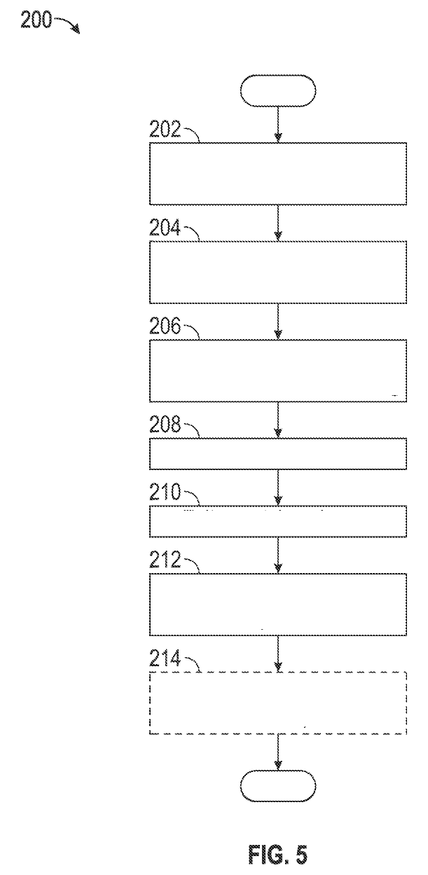

Referring to FIG. 5, a flowchart for a method 200 for managing digital access credentials for a platoon of vehicles in the de-centralized access mode 46 is illustrated. The method 200 begins at step 202. At step 202, the lead vehicle 12 communicates with the one or more follower vehicles 14, requesting data from the one or more follower vehicles 14. The method 200 proceeds with step 204.

At step 204, the one or more follower vehicles 14 transmits their respective digital-key credential data to the lead vehicle 12, allowing the lead vehicle 12 access to manage the digital-key credential data. The digital-key credential data include at least the key sharing parameter. The key sharing parameter includes at least a valid key value, a shared keys value, a shareable keys value, and an entitlement value. The valid key value identifies a start time and an end time verifying the validity of the digital-key credential data. The shared keys value identifies the values of the keys shared between the lead vehicle 12 and the one or more follower vehicles 14. The shareable keys value identifies the values which the one or more follower vehicles 14 determines which of the keys may be shared with the lead vehicle 12. The entitlement value identifies access of the lead vehicle 12 to the keys shared by the one or more follower vehicles 14. For example, the lead vehicle 12 may have full access, limited access, and drive capabilities. The digital-key credential data are received by the controller 20 of the lead vehicle 12. The method 200 proceeds with step 206.

At step 206, the lead vehicle 12 transmits the digital-key credential data from each of the one or more follower vehicles 14 to the remote back-office 38. The method 200 proceeds with step 208. At step 208, the remote back-office 38 receives the digital-key credential data and verifies the credentials of each of the digital-key credential data. The method 200 proceeds with step 210.

At step 210, the lead vehicle 12 allows the one or more follower vehicles 14 to join the platoon of vehicles 10. The method 200 proceeds with step 212. At step 212, the lead vehicle 12 transmits instructions to the one or more follower vehicles 14. The one or more follower vehicles 14 receive the instructions and execute the access transaction and/or the access negotiation with the local device 22. The method 200 proceeds with step 214. At step 214, the one or more follower vehicles 14 may deactivate access to the digital-key credential data, removing the one or more follower vehicles 14 from the platoon of vehicles 10.

The method 100 and 200 of the present disclosure offers several advantages. These include improving the aerodynamic effectiveness and performance, increasing the capacity of roads and providing a more steady-state traffic flow. Additionally, verifying the digital-key credential data of the one or more follower vehicles 14 decreases security risks in the platoon of vehicles 10.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for managing digital access credentials for a platoon of vehicles, the platoon of vehicles including a lead vehicle and one or more follower vehicles, the method comprising:
receiving, by a controller in the lead vehicle, a digital-key credential data transmitted by the one or more follower vehicles when joining the platoon of vehicles;
storing the digital-key credential data in a lead-follower key matrix that, for each follower vehicle, records at least a key sharing parameter including:
a valid key value having a start time and an end time, wherein the start time and end time verifying a validity of the digital-key credential data;
selecting, by the lead vehicle, either a centralized access mode or a de-centralized access mode for an upcoming access transaction, the selection being based on a current route segment and trajectory of the platoon of vehicles and an available number of key slots in the lead vehicle;
transmitting, by the lead vehicle, the digital-key credential data to a remote back-office;
executing, by the lead vehicle, an access transaction with a local device using credentials received from the remote back-office for the centralized access mode;
forwarding, by the lead vehicle, the credentials received from the remote back-office to a corresponding follower vehicle for the de-centralized access mode;
executing, by the one or more follower vehicles, the access transaction with the local device using the credentials received from the remote back-office for the de-centralized access mode; and
deactivating the lead vehicle access to the digital-key credential data, removing the one or more follower vehicles from the platoon of vehicles.

2. The method of claim 1, further comprising consolidating the digital-key credential data from the one or more follower vehicles within the lead-follower key matrix.

3. The method of claim 1, further comprising communicating, by the controller within the lead vehicle, instructions from the lead vehicle to the one or more follower vehicles within the platoon of vehicles.

4. The method of claim 3, wherein the instructions from the lead vehicle determines a speed of the one or more follower vehicles and an inter-distance range between consecutive vehicles.

5. The method of claim 1, wherein the digital-key credential data including a sharable attribute, wherein the sharable attribute determining the lead vehicle leaving the platoon of vehicles, and wherein the lead vehicle sharing the digital-key credential data to one of the one or more follower vehicles.

6. The method of claim 1, further comprising executing, by the one or more follower vehicles, an access negotiation with the local device using the credentials received from the remote back-office for the de-centralized access mode.

7. The method of claim 1, further comprising executing, by the lead vehicle, an access negotiation with the local device using the credentials received from the remote back-office for the centralized access mode.

8. The method of claim 7, further comprising notifying, by the lead vehicle, the one or more follower vehicles about the access transaction and the access negotiation executed on behalf of the one or more follower vehicles.

9. The method of claim 1, wherein the lead-follower key matrix has a storage threshold, wherein the storage threshold creates a limit for the lead vehicle executing the access transaction with the local device for the one or more follower vehicles in the centralized access mode.

10. The method of claim 9, wherein when one or more follower vehicles exceed the storage threshold, the one or more follower vehicles that exceed the storage threshold execute the access transaction with the local device.

11. A system for managing digital access credentials for a platoon of vehicles, the platoon of vehicles including a lead vehicle and one or more follower vehicles, the system comprising:
a controller in the lead vehicle receiving a digital-key credential data transmitted by the one or more follower vehicles when joining the platoon of vehicles;
a lead-follower key matrix storing the digital-key credential data for each follower vehicle, wherein the digital-key credential data records at least a key sharing parameter including:
a valid key value having a start time and an end time, wherein the start time and end time verifying a validity of the digital-key credential data;
a shared keys values, wherein sharing at least one key within the digital-key credential data from the one or more follower vehicles;
a shareable keys value; wherein the one or more follower vehicles determining sharable keys within the digital-key credential data;
an entitlement value, wherein the one or more follower vehicles identifying access of the digital-key credential data by the lead vehicle;
the lead vehicle selecting an access mode for an upcoming access transaction, based on a current route segment and trajectory of the platoon of vehicles and an available number of key slots in the lead vehicle, the access mode including:
a centralized access mode, wherein the lead vehicle transmits the digital-key credential data to a remote back-office, wherein the lead vehicle executing an access transaction and an access negotiation with a local device using credentials received from the remote back-office, and wherein the lead vehicle executing an access negotiation with the local device using the credentials received from the remote back-office; and
a de-centralized access mode, wherein the lead vehicle transmits the digital-key credential data to a remote back-office, wherein the lead vehicle forwarding the credentials received from the remote back-office to a corresponding follower vehicle, and wherein the one or more follower vehicles execute the access transaction and the access negotiation with the local device using the credentials received from the remote back-office, and
wherein the one or more follower vehicles removed from the platoon of vehicles, deactivating the lead vehicle access to the digital-key credential data.

12. The system of claim 11, further comprising the lead-follower key matrix of the lead vehicle consolidating the digital-key credential data from the one or more follower vehicles.

13. The system of claim 11, wherein the controller within the lead vehicle further comprising communicating instructions from the lead vehicle to the one or more follower vehicles within the platoon of vehicles.

14. The system of claim 13, wherein the instructions from the lead vehicle determines a speed of the one or more follower vehicles and an inter-distance range between consecutive vehicles.

15. The system of claim 11, wherein the digital-key credential data including a sharable attribute, wherein the sharable attribute determining the lead vehicle leaving the platoon of vehicles, and wherein the lead vehicle sharing the digital-key credential data to one of the one or more follower vehicles.

16. The system of claim 11, further comprising the lead vehicle notifying the one or more follower vehicles about the access transaction and the access negotiation executed on behalf of the one or more follower vehicles.

17. The system of claim 11, wherein the lead-follower key matrix has a storage threshold, wherein the storage threshold creates a limit for the lead vehicle executing the access transaction with the local device for the one or more follower vehicles in the centralized access mode.

18. The system of claim 17, wherein when one or more follower vehicles exceed the storage threshold, the one or more follower vehicles that exceed the storage threshold execute the access transaction with the local device.

19. A method for managing digital access credentials for a platoon of vehicles, the platoon of vehicles including a lead vehicle and one or more follower vehicles, the method comprising:
receiving, by a controller in the lead vehicle, a digital-key credential data transmitted by the one or more follower vehicles when joining the platoon of vehicles;
storing the digital-key credential data in a lead-follower key matrix that, for each follower vehicles, records at least a key sharing parameter including:
a valid key value having a start time and an end time, wherein the start time and end time verifying a validity of the digital-key credential data;
a shared keys values, wherein sharing at least one key within the digital-key credential data from the one or more follower vehicles;
an entitlement value, wherein the one or more follower vehicles identifying access of the digital-key credential data by the lead vehicle;
selecting, by the lead vehicle, either a centralized access mode or a de-centralized access mode for an upcoming access transaction, the selection being based on a current route segment and trajectory of the platoon of vehicles and an available number of key slots in the lead vehicle;
transmitting, by the lead vehicle, the digital-key credential data to a remote back-office;
communicating, by the controller in the lead vehicle, instructions from the lead vehicle to the one or more follower vehicles to:
determine a speed of the one or more follower vehicles, thereby coordinating the speed of the one or more follower vehicles with the lead vehicle; and
determine an inter-distance range between each vehicle in the platoon of vehicles;
executing, by the lead vehicle, an access transaction with a local device using credentials received from the remote back-office for the centralized access mode;
executing, by the lead vehicle, an access negotiation with the local device using the credentials received from the remote back-office for the centralized access mode;
forwarding, by the lead vehicle, the credentials received from the remote back-office to a corresponding follower vehicle for the de-centralized access mode;
executing, by the one or more follower vehicles, the access transaction with the local device using the credentials received from the remote back-office for the de-centralized access mode;
executing, by the one or more follower vehicles, the access negotiation with the local device using the credentials received from the remote back-office for the de-centralized access mode;
notifying, by the lead vehicle, the one or more follower vehicles about the access transaction and the access negotiation executed on behalf of the one or more follower vehicles; and
deactivating the lead vehicle access to the digital-key credential data, removing the one or more follower vehicles from the platoon of vehicles.

20. The method of claim 19, wherein the lead-follower key matrix has a storage threshold, wherein the storage threshold creates a limit for the lead vehicle executing the access transaction and the access negotiation on behalf of the one or more follower vehicles, and wherein when one or more follower vehicles exceed the storage threshold, the one or more follower vehicles that exceed the storage threshold execute the access transaction and the access negotiation with the local device.
